(19) United States
(12) Patent Application Publication
(10) Pub. No.: US 2009/0032415 A1
(43) Pub. Date: Feb. 5, 2009

(54) Device and holder for packaging an information carrier

(76) Inventors: Jan Wietze Huisman, Bellingwolde (NL); Willem Frederik Derkman, Amsterdam (NL)

Correspondence Address: HOFFMANN & BARON, LLP, 6900 JERICHO TURNPIKE, SYOSSET, NY, 11791, US

(21) Appl. No.: 11/921,128

(22) PCT Filed: May 23, 2006
(86) PCT No.: PCT/NL2006/000258

§ 371 Date: Feb. 19, 2008

(30) Foreign Application Priority Data
Jun. 1, 2005 (NL) 1029163

(51) Int. Cl. G11B 33/04; B65D 85/57; B65D 85/30

(52) U.S. Cl. 206/308.1; 206/493

(57) ABSTRACT

A holder for information carriers provided with an orientation surface and at least one engaging element integrated in the orientation surface for engaging the information carrier, wherein the holder is manufactured from a material produced on the basis of starch, such as Paperfoam®. A device provided with such a holder and at least one leaf part, while the at least one leaf part and the at least one holder are attached to each other.

The invention relates to a holder for information carriers, in particular for CDs, CD-ROMs or DVDs.

Known CD packages, such as a Jewel case, are manufactured substantially from plastic and, in many cases, contain a booklet or picture by way of information or presentation. As a rule, existing CD packages are also manufactured from a plastic so hard that this can relatively easily lead to damage to the CD. Existing CD-holders, as known from the Jewel case, are provided with a hub that clamps the inside edge of the CD with the aid of a number of fingers, for instance sixteen, while the circumferential edge of the CD is borne on an elevated edge so that in clamped condition, the CD does not contact further parts of the package.

It is further known to manufacture CD-packages from cardboard, in the form of a cover. Here, it is difficult to prevent it from contacting, during use, the information bearing part of the CD, so that this part becomes damaged relatively easily. Further, when placing the CD into or taking the CD from the package, it is difficult for the user not to have his fingers contact the side of the CD intended for storing information.

The object of the invention is to solve at least a number of the above-mentioned problems while maintaining the advantages and functionalities of known CD-packages.

It is also an object of the invention to provide a recyclable package for information carriers, which can be completely integrated in a paper recycling flow.

It is a further object of the invention to provide a holder manufactured from a relatively soft material so that the information carrier will become damaged less rapidly.

At least a number of these and other objects are achieved according to the invention with a holder, characterized by the features of claim 1.

Such a holder is manufactured from a material produced on the basis of starch, in particular a somewhat foamed material such as Paperfoam®. Such a material and a suitable method of production are described, for instance, in PCT/NL96/00136 and PCT/NL96/00337. Material manufactured on the basis of starch, such as Paperfoam®, is often relatively soft when compared to customary plastics used for packaging CDs and such information carriers, so that when placing a CD into or taking a CD from the holder, it will sustain scratches less rapidly. Furthermore, Paperfoam® or a similar starch-containing material has the favourable property that it is antistatic and, hence, dust-repellent. This, surprisingly, makes it a highly suitable material for holders of, for instance, CDs, DVDs and CD-ROMS, as they are to be placed into a reproducing apparatus, for instance a DVD player, as dust-free as possible. This material can further be integrated into a waste paper flow.

A further advantage of such a package is that it cannot be copied easily. As a result, the package can be used as authenticating means.

Herein, starch-containing material is at least understood to include a material which comprises natural polymers, gelatizined and cross-linked through heating, in particular baked material. Herein, relatively soft is at least understood include a surface hardness that is lower than that of CDs or DVDs to be stored.

In an advantageous embodiment, a holder according to the invention is characterized by the features of claim 2.

In order to engage and also release an information carrier, an engaging element comprises at least one resilient element. This can, for instance, principally comprise an elevation which is provided with at least one side surface for engaging the information carrier, and a press surface for moving the resilient element. Through movement of a top side, for instance pressing it, a resilient element deforms to such an extent that the information carrier is released at an engaging point of the respective engaging element. In this manner, the information carrier can be taken from or placed in the holder more easily. Owing to the suitable and elastic and/or resilient properties of the starch-containing material, the geometry of the respective at least one resilient element, and hence also the at least one engaging element, can remain relatively simple. The resilient elements can be elastically deformable parts.

Alternatively, along the circumferential edge of the information carrier, resilient or elastically deformable elements may be provided which retain the information carrier through clamping and/or form-locking manner.

In a further elaboration, a holder according to the invention is characterized by the features of claim 3.

With a holder according to this embodiment of the invention, the advantage is achieved that a relatively limited number of resilient elements functions excellently as engaging element. Owing to the softness and the resilient properties of the material, it is made possible that, with a relatively small number of resilient elements, an engaging element according to the invention, has operative properties comparably advantageous to plastic engaging elements already known, also known as “hubs”, with a relatively much higher number of moving parts, without the associated drawbacks such as many moving parts, vulnerability and the like. An advantageous embodiment of an engaging element according to the invention preferably has two resilient elements. As a result, the engaging element has a desired resilience and rigidity.

In another further elaboration, a holder according to the invention is characterized by the features of claim 4.

The at least one side surface follows substantially a rounding, for linking up with the inside edge of a central opening of, for instance, a CD, DVD or DC-ROM. The at least one side surface forms a substantially cylindrical collar which extends from the orientation surface and is bounded by at least one top side. The side surface includes segment of a circle ranging, for instance, between 40-180°, without interruption while maintaining the resilient properties of the engaging element. A relatively long side surface, including for instance 170° instead of 40°, has a favourable influence on the rigidity of the construction of the engaging element and, hence, on the retaining force that can be applied therewith on the information carrier. Optionally, the or each resilient element can further comprise projections under which the information carrier can be pressed.

An advantageous embodiment of a holder according to the invention is further characterized by the features of claim 5.

Through a recess in the orientation surface, for instance under an overhanging part of the top side(s), a product is obtained which can relatively simply be released from the mould. This also has an advantageous influence on the resilient properties of the resilient elements. As the top sides and the at least one side surface reach partly over the recess, relatively less material is to be pressed away under the overhanging part of a top side. Hence, the resilient element will bounce inward relatively more easily when the topside(s) is/are pressed in. When pressing in the resilient element with the aid of a top side, the resilient element will tilt and the side surface is pulled along so that the information carrier will be released. A further advantage is that a part of the orientation surface around the recess can deform accordingly.

Further, an advantageous embodiment of a holder according to the invention is characterized by the features of claim 6.

Elevations in the holder adjacent the edge of an information carrier placed in the holder protect the information carrier against, for instance, bumps from the outside. These elevations also hold back dust before it can end up on the information bearing part of the information carrier. The fact that the holder material is dust-repellent is an additional contribution hereto. When using this holder in combination with a package or cover parts, with the aid of the elevations, the information carrier can be enclosed completely or virtually completely.

Further, a further advantageous embodiment of a holder according to the invention is characterized by the features of claim 7.

A take-out space according to the invention offers as an advantage that the user can engage the information carrier relatively easily by the edge.

In a further elaboration, a holder according to the invention is characterized by the features of claim 8.

Also when an information carrier placed in a holder is completely or virtually completely enclosed by elevations, presently, still, by means of recesses, the information carrier in the holder can simply be engaged.

A further advantageous embodiment of a holder according to the invention is characterized by the features of claim 9.

With such an embodiment, in an integrated manner, symbols, for instance drawings or letters, are formed along in the holder. Serial numbers, information, presentation material, logos and the like may be provided without additional operations being required to that end.

An advantageous embodiment of a holder according to the invention is characterized by the features of claim 10.

The entire holder according to one embodiment of the invention, engaging elements, elevations et cetera included, consists from one mass. For obtaining a holder according to the invention, in principle, no further manufacturing or finishing operations need take place.

A further advantageous embodiment of a device according to the invention is characterized by the features of claim 11.

A holder according to the invention can be included in known devices such as packages, boxed, booklets, flyers etc. It is advantageous to include the holder in a package that can be included in a paper recycling flow, together with the holder, this is, however, not necessary. It is also favourable to include the holder in a package for information carriers such as CDs packages known per se, such as for instance a Jewel case or a Digi-tray-like package, wherein the holder is secured, for instance glued, to a cover. In a manner known per se, with the aid of leaf parts, i.e. cover parts, covers, flaps, flyer sheets or the like, information can be presented, for instance by means of added booklets or printing of a leaf part, which information relates to, for instance, information stored on the information carrier and/or possible further content or accessories of the device. Also, the information stored on the information carrier can relate to the information presented on a leaf part and/or to further content of the device.

In a further elaboration, a device according to the invention is characterized by the features of claim 12.

The holder is very suitable to, optionally, be included in existent devices with cover parts, such as a CD package. With an advantageous embodiment, a holder is for instance glued on a cover part of an existing Jewel case or Digi-tray CD package. Upon snapping shut, the information carrier included in the holder is covered by another cover part hinged to this cover part and/or connected thereto in a foldable manner. A holder according to the invention can, in principle, be included in any existing package for information carriers.

In a further elaboration, a holder according to the invention is characterized by the features of claim 13.

A further elaboration of cardboard packages of information carriers with which a holder according to the invention can be advantageously integrated, is a CD package in which several cover parts can be folded-out and folded-in. This embodiment according to the invention may be utilized with packages for double CDs, or when very many folding-out parts are desired.

A manner of manufacture which can be used for a holder according to the invention is described in, for instance, PCT/NL96/00337, incorporated herein by reference.

In clarification of the invention, exemplary embodiments thereof will be described on the basis of the drawing. In the drawing:

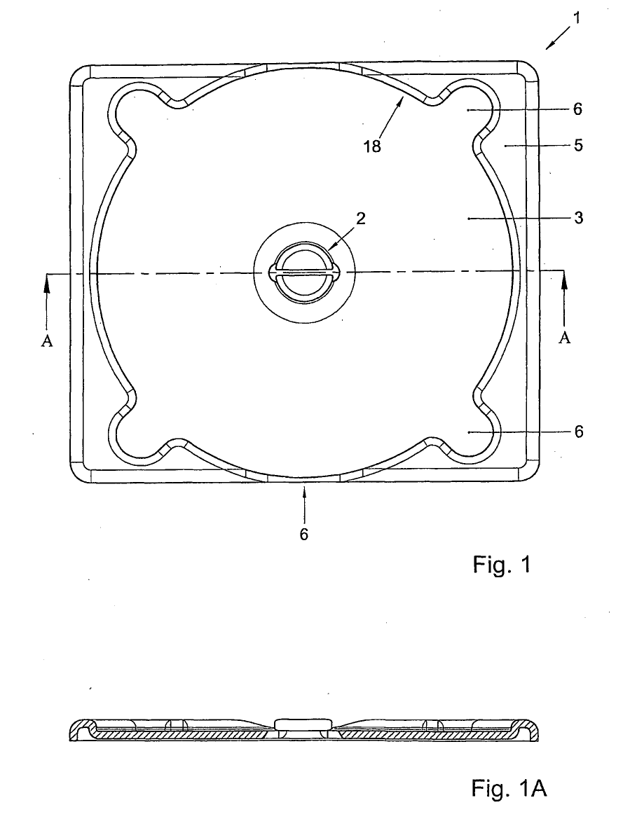

FIG. 1 shows, in top view, of a holder according to the invention;

FIG. 1a shows a holder, in cross-sectional side view along the line A-A in FIG. 1;

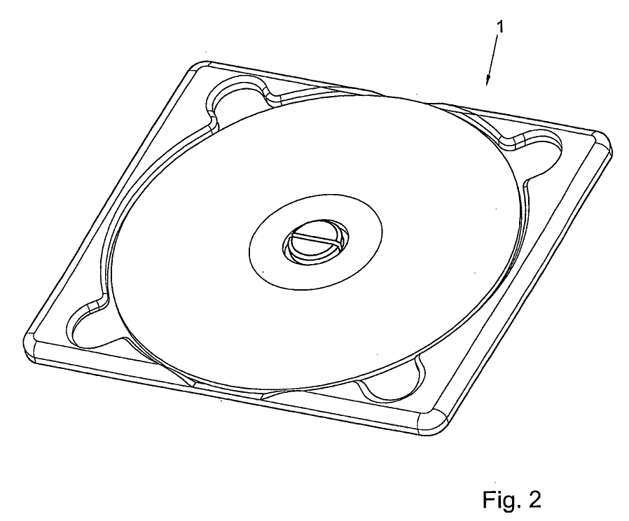

FIG. 2 shows, in perspective top view, a holder with a CD placed therein according to the invention;

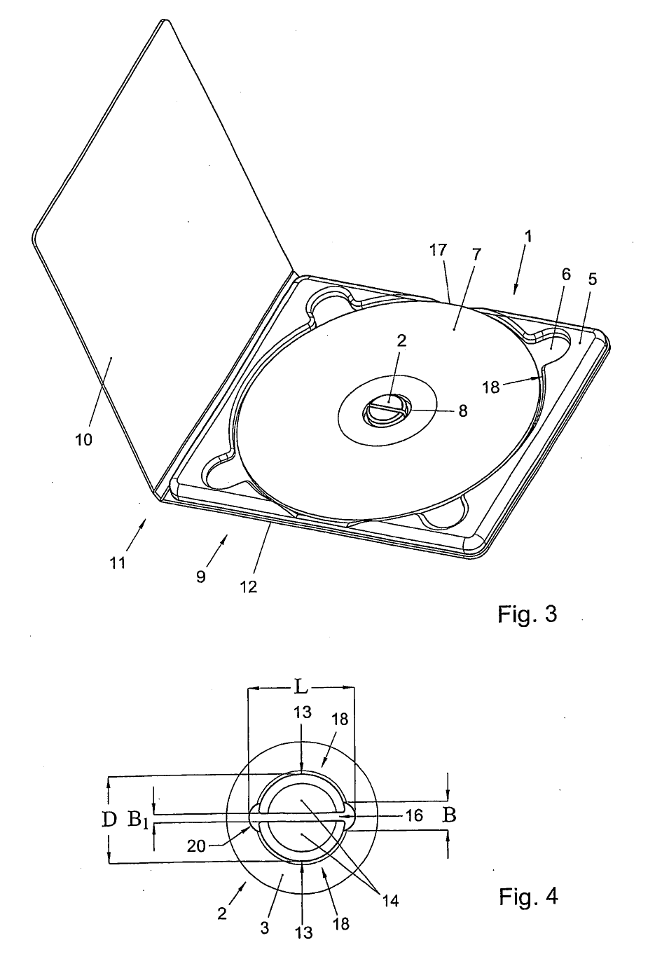

FIG. 3 shows, in perspective top view, a folded-open CD package with a holder with a CD placed therein according to the invention;

FIG. 4 shows, in top view, an engaging element according to the invention;

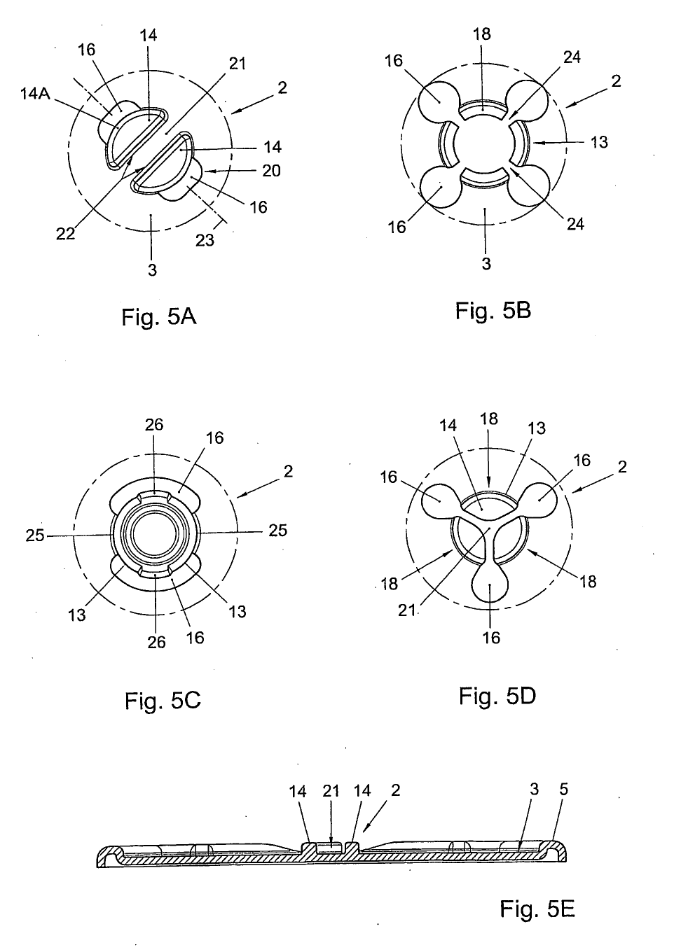

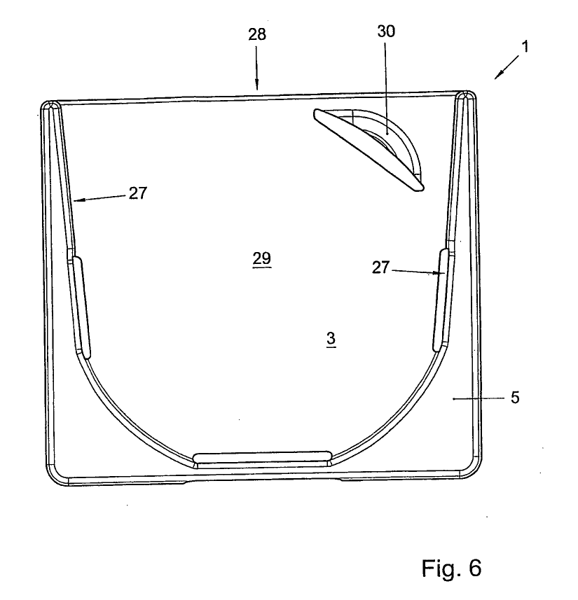

FIGS. 5A-D show alternative embodiments of an engaging element according to the invention;

FIG. 5E shows, in cross-sectional side view comparable to FIG. 1, a holder according to FIG. 5A;

FIG. 6 shows a first alternative embodiment of a holder according to the invention;

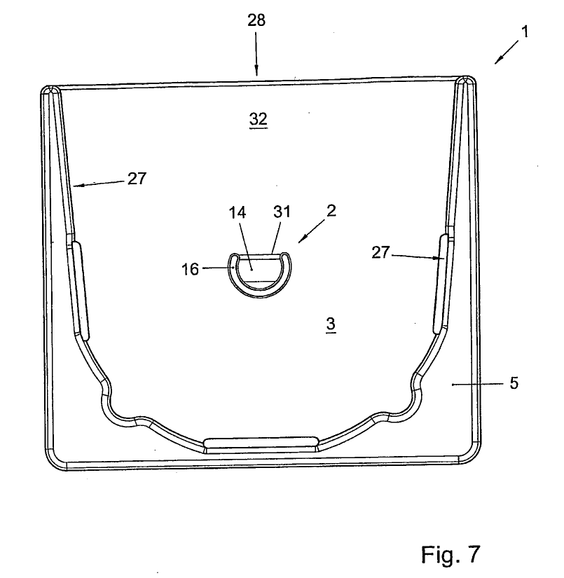

FIG. 7 shows a second alternative embodiment of a holder according to the invention;

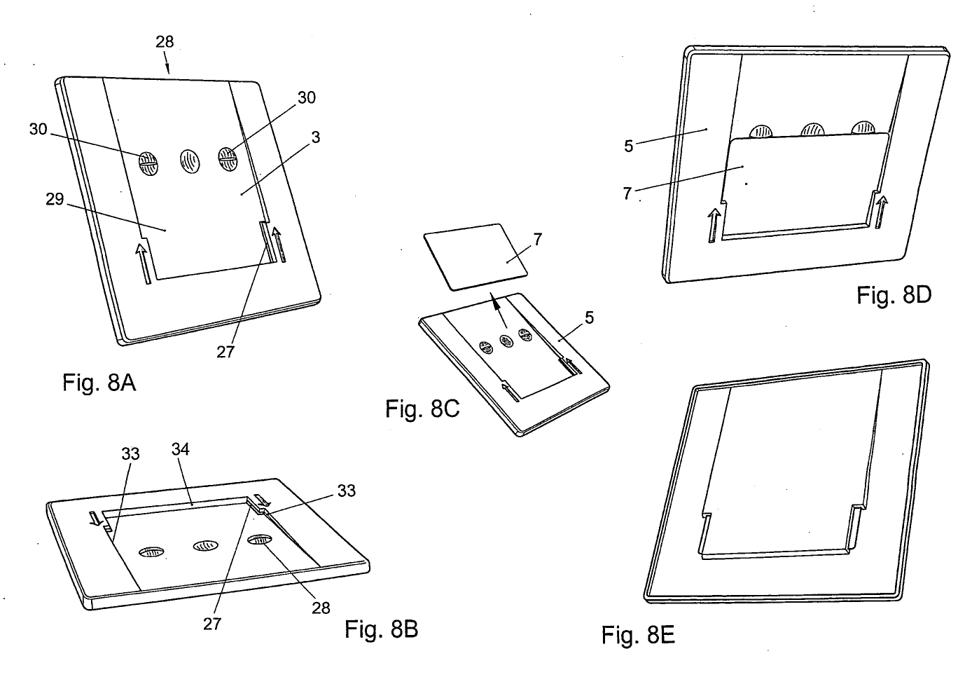

FIGS. 8A and B show a perspective front view of a further alternative embodiment of a package according to the invention;

FIG. 8C shows taking the card out of the holder according to FIG. 8A;

FIG. 8D shows, in perspective top view, a holder with a card placed therein according to FIG. 8A; and

FIG. 8E shows the rear side of the holder according to FIG. 8A.

These embodiments shown should not be construed to be limitative in any manner. In this description, identical or corresponding parts have identical or corresponding reference numerals.

FIG. 1 shows, in top view, a holder 1 according to the invention. This holder 1 is manufactured from material produced on the basis of starch, in this embodiment of the invention, this is Paperfoam®. In the holder 1 shown, a CD, DVD, CD-ROM, a card such as a chip card, memory card or credit card or a similar information carrier 7 can be retained with the aid of an engaging element 2. This is shown, in top view, in FIG. 2. The engaging element 2 is provided on a substantially flat surface, to be called orientation surface 3.

The orientation surface 3 comprises, adjacent a circumference 17, one or more elevations 5, while adjacent a middle part of the orientation surface 3, the engaging element 2 is provided. The information carrier 7 can be placed over the engaging element 2 by a central opening, preferably with an information bearing side facing the orientation surface 3. The information carrier 7 can be clamped by the engaging element 2 such that, in principle, the information bearing part does not contact the orientation surface 3. However, a holder manufactured by means of natural polymers such as starch, in particular a holder manufactured from Paperfoam®, offers the advantage that such contact is not disadvantageous. The information bearing side of the information carrier 7 can contact the orientation surface without damage occurring. As a result, the design of the holder 1 can be even simpler. Furthermore, this offers an even better protection. In particular Paperfoam® or such material is advantageous because of its relative softness and antistatic properties.

The holder can be attached by means of a rear side of the orientation surface 3 to other devices, for instance through gluing, as shown in FIG. 3.

The elevations 5 protect the information carrier 7, in particular the information bearing part and the side of the information carrier 7, against, for instance, dust or bumping. To that end, inside contours 18 of elevations 5 proceed along outside edge 17 of the information carrier 7. Also, a different holder with information carrier 7 can be placed on the elevations 5 and in this manner, holders 1 can be stacked, without contacting information carriers 7 included therein.

FIG. 2 shows that take-out spaces 6 are provided in which the outer edge 17 of an information carrier can simply be engaged by fingers and be taken from the holder 1.

FIG. 3 shows a CD package 9 known per se in which holder 1 is included. The CD package 9 comprises a first cover 10 and a second cover 12, while the rear side of the holder 1 is glued against the second cover 12. Cover 10 can be pivoted along a fold line 11 to a position in which it can cover the information carrier 7. First cover 10 can consist of several cover parts, for instance for the presentation of more information, or for fastening a further holder 1 to a further cover part, for instance when a double CD is issued. It may for instance be the case that cover part 10A,B are provided, mutually connected by a fold line, which, together, form the first cover part 10 and can be folded shut flatly against each other, to form, as it were, one cover, whereupon this is folded shut as cover 10 over the information carrier 7. Preferably, the cover parts 10, 12 are manufactured from material that can be included in a paper recycling flow, in particular paper or cardboard. Thus, in combination with a holder 1 manufactured on the basis of starch, a package is obtained which can be integrally included in a paper recycling flow.

Use of a starch-based material for a holder 1 according to the invention, in particular Paperfoam, offers the additional advantage that such a holder cannot be copied easily. Other than existing CD and DVD boxes, such as Jewel cases, which are manufactured universally on known, universal machines, in large numbers, a holder according to the invention will necessitate special machines. The holders 1 according to the invention can simply be manufactured to be dedicated, i.e. especially for a particular information carrier or series of information carriers, for instance through printing, reliefs or the like adapted thereto. With this, a direct link can be effected between the information carrier and the package so that the package, at least the holder 1 according to the invention, can be an authenticating means, a means that can be used by a manufacturer or user, for instance as proof that the information carrier comes from the original supplier and is not an illegal copy.

Further, FIG. 4 shows a top plan view of the engaging element 2 of the holder 1, provided with resilient elements 18 and a recess 16. A resilient element 18 is provided with a side surface 13 and a top side 14. By pressing a top side 14, approximately at right angles to the plane of the drawing, or by pressing against the side surface 13, side surface 13 will be moved in the direction of the centre of the orientation surface 3. To that end, side surface 13 will press less against the inside edge 8 of the CD 7 and the information carrier 7 can simply be taken from the holder 1.

FIG. 4 shows that the engaging element 2 is substantially cylindrical with an end surface forming the top side 14, transected by the recess 16. In the orientation surface 3, the recess 16 is slot-shaped with a length L which is greater than the diameter D of the engaging element 2, a width B which is smaller than this diameter D, and which has rounded-off ends 20. In the top side 14, the recess has a width B₁ which is smaller than the width B of the slot in the orientation surface, so that parts of the top side 14 extend above this slot 16 in the orientation surface 3. As a result, the resilience of the resilient elements 18 is improved and yet a relatively large top surface 14 is maintained.

In the orientation surface 3, through relief on for instance the rear side, information can be provided with respect to, for instance, the manufacturer, the material used, serial numbers and the like. Such reliefs, for that matter, can also be provided on the front side.

In FIGS. 5a-E, alternative embodiments are given of an engaging element or hub 2.

In the embodiment shown in FIG. 5A, a substantially cylindrical hub is provided, transected by a slot 21 which runs through the centre and is closed on both sides by a wall 22. Again, a top side 4 is provided which is closed, except for the slot 21. In the orientation surface 3, a recess 16 is provided on two opposite sides of the hub 2 such that jointly, they define an axis 23 which extends approximately at right angles to a longitudinal direction of the slot 21. The wall of the hub is removed at the location of the two recesses 16, thereby obtaining a part 14A of each top surface 14 slightly overhanging the recess. The wall of the hub is further preferably somewhat counter-releasing so that extra grip on the CD can be obtained. Such a counter release can be applied with any hub 2.

FIG. 5E shows, in cross-section, a holder 1 according to the invention with a hub 2 according to FIG. 5A, which cross-section transects the two parts of the hub, between the recesses 16.

FIG. 5B shows, in top view, a hub 2 according to the invention wherein a cylindrical wall 13 is provided, transected such that four resilient elements 18 are obtained. At each opening 24 between two resilient elements 18, a somewhat circular recess 16 is provided in the orientation surface 3. The resilient elements are mutually freely resilient.

FIG. 5C shows an engaging element with a substantially cylindrical wall 13, on both sides of which, in the orientation surface 3, a recess 16 in the shape of a segment of a circle is provided such, that the hub 2 is connected to the orientation surface via two relatively narrow bridges 25. On two opposite sides, at a distance from the orientation surface, the hub is provided with a projecting clamping element 26 under which an information carrier can be secured when this is pressed on the hub in a manner known per se.

FIG. 5D shows an embodiment of an engaging element or hub 3 wherein a substantially cylindrical hub is provided with a side wall 13 and a top surface 14. The hub 2 is transected by a star-shaped slot ending three-sidedly in a recess 16 in the orientation surface 3, so that three resilient elements 18 are obtained.

In FIG. 6, an alternative embodiment of a holder 1 according to the invention is shown, which can be provided with a hub 2 or similar engaging element which is centrally arranged, as shown and described in, for instance, one of the above-mentioned Figures. With this embodiment, the elevation 5 is substantially U-shaped and at least partly provided with an undercut 27 in a manner such that an information carrier such as a CD or DVD can be slid therein by a portion of its circumferential edge. Adjacent the open side 28 of the U-shaped receiving position for the information carrier, a resilient confining element 30 is provided over which the information carrier can be slid, as far as into the undercut. In this position, the resilient element 30 bounces back to the initial position and confines the information carrier in the undercut. For taking out the information carrier, the element 30 is pressed downwards so that the information carrier can be slid over it.

In FIG. 7, an embodiment is shown which is comparable to that of FIG. 6. Here, however, the resilient element 30 is designed as a centrally arranged hub 2 which is connected, with a to the opening 32 of the U-shaped receiving position 29, via a lip 33, to the orientation surface 3. In this embodiment, the information carrier can be slid via the opening 32 into the receiving position, to a point where the circumferential edge is partly received in the undercut 27, and the hub bounces back in the central opening of the information carrier from a position pressed away downwardly. For taking out the information carrier, the hub 2 is again pressed down, from its central opening, whereupon the information carrier can be slid away (upward in the drawing), through the opening 32.

In FIGS. 8A-E, five views are shown of a further embodiment of a package, at least holder according to the invention, suitable for including card-shaped information carriers 7 such as chip cards, memory cards or credit cards. As a rule, such cards have a substantially rectangular shape and no central opening such as CDs. In this embodiment, on a top side of the orientation surface 3 (FIGS. 8A-D), a substantially U-shaped elevated edge 5 is provided with, on one side, an opening 28 through which an information carrier 7 can be slid. Within the edge 5, a receiving position 29 is provided for the information carrier 7. The receiving position is bounded on two opposite sides by a straight wall 39 and, on a bottom side, by an end wall 34. Opposite the end wall 34 is provided the opening 28. Between the end wall 34 and the opening 28, two resilient elements 30 are provided in the orientation surface 3, over which the information carrier can be slid such that it can be slid from near the opening 28, parallel to the orientation surface 3, in the direction of the end wall 34. Adjacent the end wall, on both sides of the receiving position, in each side wall 33, an undercut 27 is provided under which a part of the information carrier 7 can be slid for securing this in a direction transverse to the orientation surface 3. The further elements 30 then confine the information carrier in a direction of the opening 28 such that the information carrier can only be taken from the take out position after the resilient elements 30 are pressed down.

The invention is not limited in any manner to the represented embodiments. For instance, instead of combined with a package, a holder can be combined with all sorts of devices. Further, several holders can be received in different directions. These and comparable variations are understood to fall within the framework of the invention.

1. A holder for information carriers, provided with an orientation surface and at least one engaging element integrated in the orientation surface for engaging the information carrier, wherein the holder is manufactured from a material produced on the basis of starch, such as Paperfoam®.

2. A holder according to claim 1, wherein an engaging element is provided with at least one resilient element, while a resilient element is provided with a side surface and a top side, the side surface connecting the top side to the orientation surface and the top side extending at a distance from, and preferably approximately parallel to the orientation surface.

3. A holder according to claim 2, wherein an engaging element comprises a series of resilient elements, in particular two.

4. A holder according to claim 2, wherein the engaging element is substantially cylindrical, transected by at least one slot.

5. A holder according to claim 1, wherein the orientation surface is provided with at least one recess at the engaging element.

6. A holder according to claim 1, provided with at least one elevation relative to the orientation surface near the outside edge of an information carrier placed in the holder.

7. A holder according to claim 1, provided with at least one take-out space for taking out the information carrier.

8. A holder according to claim 6, wherein a take-out space comprises a recess in an elevation.

9. A holder according to claim 1, wherein at least one symbol is provided in the holder.

10. A holder according to claim 1, which is manufactured from substantially one mass.

11. A device, provided with at least one holder according to claim 1 and at least one leaf part, wherein the at least one leaf part and the at least one holder are attached to each other.

12. A device according to claim 11, wherein the or each leaf part comprises cover parts which are pivotally connected to each other and/or to the holder such, that at least one of the cover parts can be folded against the holder.

13. A device according to claim 12, provided with at least two cover parts which can snap shut to a position parallel to the information carrier.

14. A device according to claim 11, wherein said at least one leaf part is manufactured from a material to be included in a paper recycling flow, preferably from cardboard or paper.
